(19) United States
(12) Patent Application Publication
(10) Pub. No.: US 2010/0061654 A1
(43) Pub. Date: Mar. 11, 2010

(54) Scatter estimation and reduction method and apparatus

(75) Inventor: Joseph J. Manak, Albany, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/583,650

(22) Filed: Oct. 19, 2006

(51) Int. Cl. G06K 9/40

(52) U.S. Cl. 382/275

(57) ABSTRACT

A method and system are provided for removing or reducing the scatter within the image. In the present technique, two images are acquired at different energies such that one image, typically the higher energy image, provides an estimate of the scatter in the image. In one embodiment, the image providing the estimate of scatter is subtracted from the other image to provide a scatter-reduced image. In another embodiment, a low-frequency image is generated from the image providing the estimate of scatter and the low-frequency image is subtracted from the other image to provide the scatter-reduced image. One or more weighting factors, such as multiplicative weighting factors may be applied to the involved images prior to subtraction.

### STATEMENT REGARDING FEDERALLY SPONSORED RESEARCH & DEVELOPMENT

This invention was made with Government support under contract number DAMD 17-00-2-0009 awarded by the Department of Defense. The Government has certain rights in the invention.

### BACKGROUND

The invention relates generally to imaging techniques and, more specifically, to techniques for estimating and reducing scatter in an X-ray imaging system.

Non-invasive imaging broadly encompasses techniques for generating images of the internal structures or regions of an object or person that are otherwise inaccessible for visual inspection. One of the best known uses of non-invasive imaging is in the medical arts where these techniques are used to generate images of organs and/or bones inside a patient which would otherwise not be visible. Examples of such non-invasive imaging modalities include X-ray radiography and other X-ray based imaging techniques, such as tomosynthesis.

For example a medical X-ray radiography system typically operates by projecting X-rays from an X-ray source through an imaging volume. A portion of the X-rays pass through, and are attenuated by, a portion of a patient, such as the chest or an arm or leg. The attenuated X-rays are detected by an array of detector elements that produce signals representing the attenuation of the incident X-rays. The signals are processed and reconstructed to form images of the imaged region.

For example, a digital detector may be comprised of an array of individual photodetectors disposed beneath a single, monolithic scintillator or individual scintillators. The scintillators typically generate optical light when impacted by X-rays. The photodetectors, in turn, detect the optical light and generate responsive electrical signals that can be read out and, based on the location of the photodetector on the panel, used to generate an image.

However, various physical factors associated with the X-ray imaging process may lead to artifacts in the resulting images or to blurring or generally poor image quality. For example, X-rays photons emitted through the imaging volume may pass through the patient or other object being imaged or be absorbed by the patient or object and thus never reach the detector. The amounts of X-ray photons passing through the patient and the amount absorbed are useful to produce the desired radiographic images as this information is indicative of the composition and structure of the patient or object undergoing imaging. However, a third possibility is that an X-ray photon will undergo Compton scattering and be deflected from its trajectory through the patient or object. As a general rule, higher-energy X-ray photons are more likely to be scattered (rather than absorbed) than lower-energy X-ray photons. Unlike absorbed X-ray photons, a scattered X-ray photon may eventually reach the detector apparatus but typically along a different trajectory. As a result, a scattered X-ray photon may impact the detector at a location or from a direction that conveys no useful composition or structural information about the patient or object undergoing imaging. As a result, the scattered X-ray photons may lead to blur within the resulting radiographic image or otherwise reduce the image quality.

### BRIEF DESCRIPTION

A method for generating images is provided. The method includes the act of acquiring a first image and a second image. The first image is acquired at a lower energy than the second image. The second image is subtracted from the first image to generate a scatter-reduced image. Corresponding claims to tangible, machine readable media comprising code executable to perform these acts are also provided.

A method for generating images is provided. The method includes the act of acquiring a first image and a second image. The first image is acquired at a lower energy than the second image. At least a low-frequency image and a high-frequency image are generated based on the second image. At least the low-frequency image is subtracted from the first image to generate a scatter-reduced image. Corresponding claims to tangible, machine readable media comprising code executable to perform these acts are also provided.

An imaging system is provided. The imaging system includes a detector array comprising a plurality of detector elements and a source configured to emit radiation toward the detector array at two or more energy levels. The imaging system also includes a system controller configured to control operation of at least one of the detector array or the source and an image processing component. The image processing component is configured to process signals generated by the detector array in response to radiation emitted at a first energy to generate a first image and to process signals generated by the detector array in response to radiation emitted at a second energy to generate a second image. In addition, the image processing component is configured to subtract the second image from the first image to generate a scatter-reduced image.

An imaging system is provided. The imaging system includes a detector array comprising a plurality of detector elements and a source configured to emit radiation toward the detector array at two or more energy levels. The imaging system also includes a system controller configured to control operation of at least one of the detector array or the source and an image processing component. The image processing component is configured to process signals generated by the detector array in response to radiation emitted at a first energy to generate a first image and to process signals generated by the detector array in response to radiation emitted at a second energy to generate a second image. In addition, the image processing component is configured to generate at least a low-frequency image and a high-frequency image based on the second image and to subtract at least the low-frequency image from the first image to generate a scatter-reduced image.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an exemplary imaging system in the form of a radiographic X-ray imaging system for use in producing images in accordance with aspects of the present technique;

FIG. 2 is a flowchart depicting exemplary actions for processing images acquired using the system of FIG. 1, in accordance with aspects of the present technique;

FIG. 3 is a flowchart depicting exemplary actions for processing images acquired using the system of FIG. 1, in accordance with an additional aspect of the present technique;

FIG. 4 is a flowchart depicting exemplary actions for processing images acquired using the system of FIG. 1, in accordance with another aspect of the present technique; and

FIG. 5 is a flowchart depicting exemplary actions for processing images acquired using the system of FIG. 1, in accordance with a further aspect of the present technique.

### DETAILED DESCRIPTION

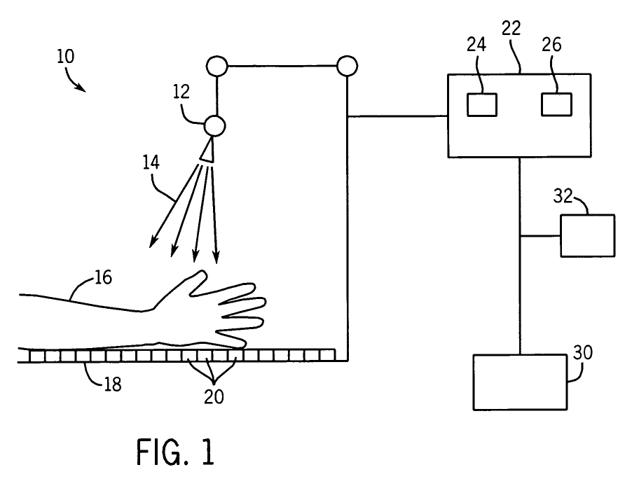

FIG. 1 illustrates diagrammatically an imaging system 10 for acquiring and processing projection data to generate radiographic images in accordance with the present technique. In the illustrated embodiment, system 10 is a radiographic X-ray imaging system designed both to acquire original image data and to process the image data for display and analysis in accordance with the present technique. In other embodiments, the system 10 is a tomosynthesis system or other system in which images are acquired over a limited number of view angles. The system 10 comprises an X-ray source 12 configured to emit X-rays 14. In one exemplary embodiment the X-ray source 12 is an X-ray tube. In other embodiments the X-ray source 12 may be a solid-state or thermionic X-ray source, or may be other sources of X-ray radiation suitable for the acquisition of medical images.

The X-rays 14 pass through a region in which an object, such as the arm 16 of a patient, is positioned. A portion of the X-ray radiation 14 passes through or around the object and impacts a detector array 18. Detector elements 20, i.e., pixels, of the array 18 produce electrical signals that represent the intensity of the incident X-rays 14. These signals are acquired and processed to generate images of the features within the object, such as arm 16 in the depicted example. In one embodiment the detector array 18 comprises a flat panel detector, such as a monolithic type detector array consisting of a large and/or continuous scintillation surface overlaying a photodetection assembly, such as an array of photodiodes.

Source 12 is controlled by a system controller 22, which furnishes both power, and control signals for radiographic examinations. In the depicted embodiment, the system controller 22 controls the source 12 via an X-ray controller 24, which may be a component of the system controller 22. In such an embodiment, the X-ray controller 24 may be configured to provide power and timing signals to the X-ray source 12 and/or to otherwise control the activation and operation of the X-ray source 12.

Moreover, the detector 18 is coupled to the system controller 22, which commands acquisition of the signals generated in the detector 18. In the depicted embodiment, the system controller 22 acquires the signals generated by the detector 18 using a data acquisition system 26. The data acquisition system 26 receives data collected by readout electronics of the detector 18. In one embodiment, the data acquisition system 26 receives sampled analog signals from the detector 18 and converts the data to digital signals for subsequent processing by an image processing component 30. In alternative embodiments, the readout circuitry of the detector 18 converts the signals to a digital form prior to providing the signals to the data acquisition system 26. The data acquisition system 26 may execute various signal processing and filtration functions with regard to the acquired image signals, such as for initial adjustment of dynamic ranges, interleaving of digital image data, and so forth.

In general, system controller 22 commands operation of the imaging system 10 (such as via the operation of the source 12 and detector 18) to execute examination protocols and to process acquired data. In the present context, system controller 24 also includes signal processing circuitry, typically based upon a general purpose or application-specific digital computer, associated memory circuitry for storing programs and routines executed by the computer (such as routines for executing image processing and reconstruction techniques described herein), as well as configuration parameters and image data, interface circuits, and so forth.

In the depicted embodiment, the image signals acquired and processed by the system controller 24 are provided to the image processing component 30 for generation of images. The processing component 30 may consist of or include one or more conventional microprocessors or special purpose processors, such as graphics coprocessors. The data collected by the data acquisition system 26 may be transmitted to the processing component 30 directly or after storage in a memory. It should be understood that any type of memory suitable to store a large amount of data might be utilized by such an exemplary system 10. Moreover, the memory may be located at the acquisition system site or may include remote components for storing data, processing parameters, and routines for image processing and reconstruction.

The processing component 30 is configured to receive commands from and to output images to an operator via an operator workstation 32 typically equipped with a keyboard and other input devices. An operator may control the system 10 via the input devices. Thus, the operator may observe the acquired images and/or otherwise operate the system 10 via the operator workstation 40. For example, a display on the operator workstation 32 may be utilized to observe the generated images and to control imaging. Additionally, the images may also be printed to a printer that may be a component of or coupled to the operator workstation 32.

Further, the processing component 30 and operator workstation 32 may be coupled to other output devices, which may include standard or special purpose computer monitors and associated processing circuitry. One or more operator workstations 32 may be further linked to the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 32 may also be coupled to a picture archiving and communications system (PACS). Such a PACS might be coupled to a remote client, radiology department information system (RIS), hospital information system (HIS) or to an internal or external network, so that others at different locations may gain access to the image, the image data, and optionally the variance data.

While the preceding discussion has treated the various exemplary components of the imaging system 10 separately, one of ordinary skill in the art will appreciate that some or all of these various components may be provided within a common platform or in interconnected platforms. For example, the processing component 30, memory, and operator workstation 32 may be provided collectively as a general or special purpose computer or workstation configured to operate in accordance with the present technique. Likewise, the system controller 22 may be provided as part of such a computer or workstation.

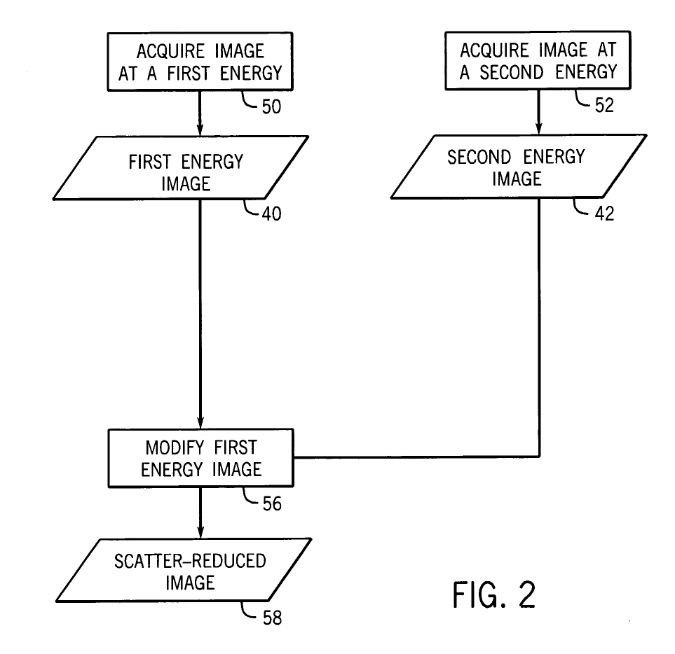

In one embodiment of the present technique, the system 10 of FIG. 1 is used to acquire radiographic data and generate useful medical images in which the effects of X-ray scatter are reduced. For example, referring to FIG. 2, exemplary acts for reducing the effects of X-ray scatter using the system 10 of FIG. 1 are depicted. In the depicted embodiment of FIG. 2, two images of a patient or object are consecutively or sequentially acquired. The images are acquired using X-rays having different energy profiles such that, in one embodiment, a first image 40 is acquired (Block 50) at a first energy and a second image 42 is acquired at a second energy (Block 52). As will be appreciated by those of ordinary skill in the art, the different energies at which the first and second images 40, 42 are acquired may vary depending on the application. For example, in a chest imaging implementation, the first energy image 40 may be acquired at a peak kilovoltage (kVp) of between about 70 kVp to about 80 kVp at 40 mA, while the second energy image 42 may be acquired at about 120 kVp at 5 mA. However, in a mammography implementation, the first energy image 40 may be acquired at a peak kilovoltage (kVp) of between about 20 kVp to about 30 kVp while the second energy image 42 may be acquired at about 60 kVp. In such implementations, the first energy image 40 may be construed as a low-energy image relative to the second energy image 42, i.e., the high-energy image. As a result, in this implementation, the first energy image 40 would typically provide high contrast while the second energy image 42 would have relatively lower contrast and may possible include image blurring due to scatter.

The second energy image 42, however, may be used to estimate scatter. In particular, The Compton scatter cross section is relatively independent of the X-ray energy in the range typically employed for imaging (i.e., 20 to 200 KeV) and of atomic number. As a result, the scatter distribution within a sample will have a similar profile for both low and high energy images, i.e., first energy image 40 and second energy image 42 in the present context, and for different sample compositions. In addition, the photoelectric cross-section varies substantially within the typical X-ray energy range, dropping off quickly as X-ray energy increases. Therefore, the first energy image may be modified (Block 56) to generate a scatter-reduced image 58 by subtracting the second energy image 42, i.e., the higher energy image in this example, on a pixel-by-pixel basis. In one embodiment, the first and second energy images 40, 42 are weighted, such as with suitable multiplicative factors, to achieve the desired degree of scatter reduction while preserving a suitable degree of contrast and resolution within the scatter-reduced image 58.

For example, in one implementation performed with a chest phantom in which half of the phantom was covered with a 3 mm lead sheet, substantial blurring was observed near the edge of the lead sheet due to scattered X-rays from the uncovered portion of the phantom. A first energy image 40 was acquired at 70 kVp and 40 mA (0.4 mAs) while a second energy image 42 was acquired at 120 kVp and 5 mA (0.4 mAs). In this implementation, the second energy image 42 was multiplied by 0.22 and the product subtracted on a pixel-by-pixel basis from low energy image 40 to generate a scatter-reduced image 58. The scatter-reduced image 58 was observed to have less blurring in the portion of the image corresponding to the uncovered part of the phantom and the image resolution increased from 2.5 lp/mm to 2.8 lp/mm.

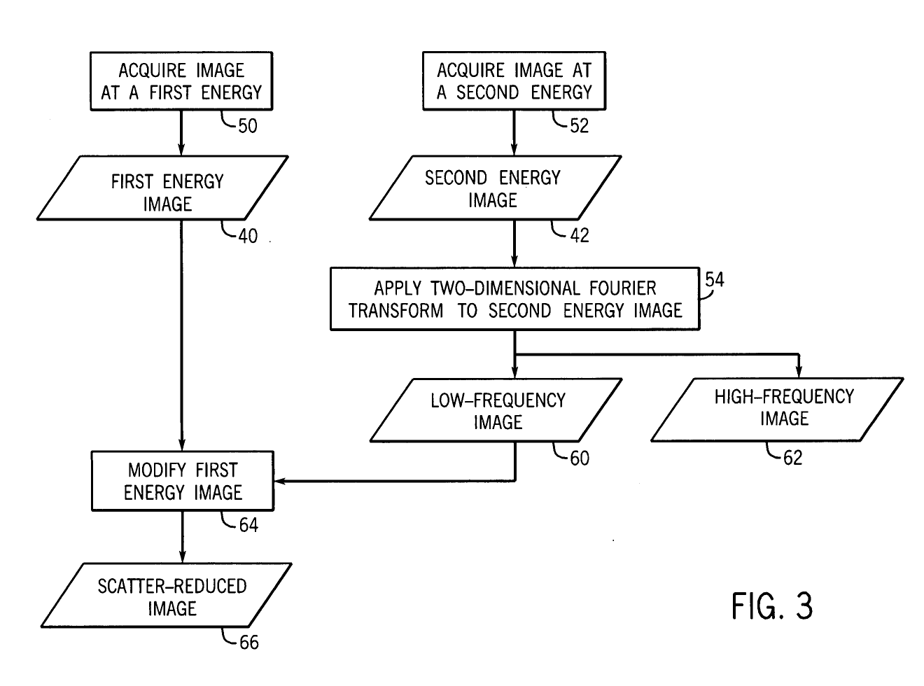

Turning now to FIG. 3, in a further embodiment of the present technique, a two-dimensional frequency based transform, such as a two-dimensional Fourier transform, is applied (Block 54) to the second energy image 42 to generate the frequency components for the second energy image 42. These generated frequency components may be categorized as being either low-frequency, depicted by the low-frequency image 60, or high-frequency, depicted by the high-frequency image 62. In general, the low-frequency image 60 corresponds to X-ray scatter while the high-frequency image 62 correspond to useful image data, such as image data for bone or other dense structures amenable to imaging at high energy, as set forth in the present implementation.

As will be appreciated by those of ordinary skill in the art, the separation of second energy image 42 into low and high-frequency images 60, 62 may be based on the nature or shape of the distribution of the frequency components, such as discernible bi- or multi-modality of the distribution or other obvious break points in the distribution. Alternatively, the separation of the low and high-frequency components may be based on an empirically derived value or threshold based on known scatter levels and imaging applications or on other thresholds derived by the operator. Further, in one embodiment, the operator may interactively adjust the break point between the low and high-frequency components to achieve the desired degree of scatter reduction, and the desired image quality, as discussed in greater detail below. It should be noted that a hard cutoff in frequency may result in imaging artifacts. Therefore, in one embodiment, the separation in frequency is done by weighting the two-dimensional Fourier transform image by a two-dimensional function that smoothly varies with frequency. In one such embodiment, the low-frequency component image 60 is obtained by multiplying the two-dimensional Fourier transform image by a function with high (near unity) values at low frequencies that drops off to zero at high frequencies. Likewise, the high-frequency component image 62 is obtained by applying the inverse of the same function. For example, in one set of experiments, a sigmoid function and its inverse were employed to separate the low and high-frequency image components.

In the embodiment depicted in FIG. 3, the first energy image 40, such as a low-energy image, is modified (Block 64) by subtracting the low-frequency image 60 from the first energy image 40 to produce a scatter-reduced image 66. In one embodiment, the unweighted low-frequency image 60 is subtracted pixel-by-pixel from the first energy image 40 to produce the scatter-reduced image 66. In another embodiment, the low-frequency image 60 is weighted, such as by a multiplicative factor, prior to being subtracted from the first energy image 40 to produce the scatter-reduced image 66. In such an embodiment, the weighting factor or factors may be empirically determined to achieve the desired level of scatter reduction.

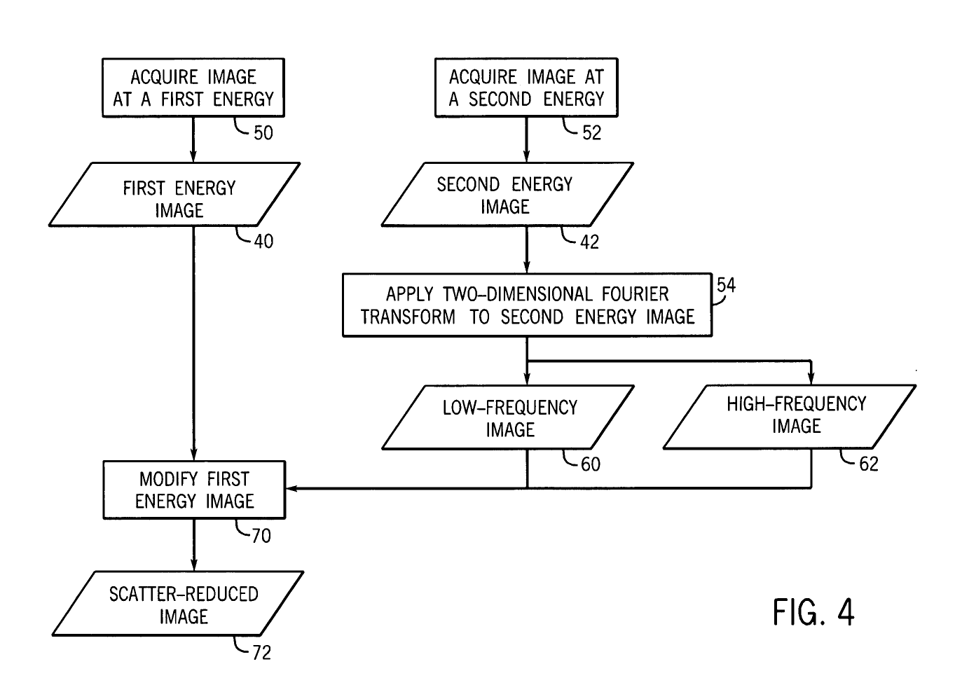

Turning now to FIG. 4, in a further embodiment the first energy image 40 is modified (Block 70) by not only subtracting the (weighted or unweighted) low-frequency image 60 but by adding the high-frequency image 62 to generate the scatter-reduced image 72. As will be appreciated by those of ordinary skill in the art, the high-frequency image 62 may also be weighted or unweighted, depending on the level of detail present in the high-frequency image 62 which is desired in the scatter-reduced image 72. In this way, the second energy image 42 may be used to enhance desired features of the scatter-reduced image 72 in addition to reducing the scatter present in the image 72. In this manner, the contrast of the scatter-reduced image 72 may be maintained or improved while concurrently removing scatter.

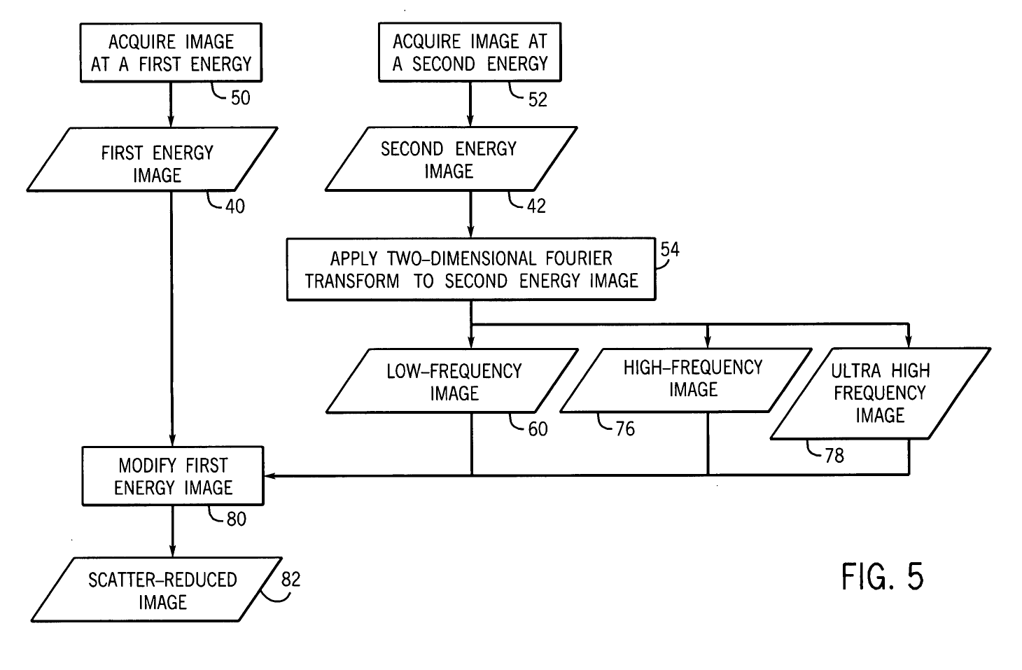

In a further embodiment, turning now to FIG. 5, additional artifacts may be removed from the first energy image 40. In this embodiment, the frequency components for the second energy image 42 are further separated. In particular, The generated frequency components are categorized as being low-frequency, depicted by the low-frequency image 60, high-frequency, depicted by the high-frequency image 76, or ultra-high frequency, depicted by the ultra high-frequency image 78. While, as noted above, the low-frequency image 60 corresponds to X-ray scatter and the high-frequency image 62 correspond to useful image data, the ultra high-frequency image 78 generally corresponds to electronic noise.

In the embodiment depicted in FIG. 5, therefore, the first energy image 40 is modified (Block 80) by subtracting the (weighted or unweighted) low-frequency image 60, by adding the (weighted or unweighted) high-frequency image 72, and by subtracting all or part of the ultra high-frequency image 78 to generate the scatter-reduced image 82. In this way, both the scatter and the electronic noise that are identifiable from the second energy image 42 may be reduced or removed from the first energy image 40 to generate the scatter-reduced image 82.

In view of the techniques described above, scatter can be reduced in radiographic images without the use of scatter grids associated with the detector array 18, thereby allowing lower X-ray doses to be employed while still obtaining useful images. Likewise, there is no need for an operator to know the exact geometry of the imaged system, i.e., the air gap or sample thickness to address image degradation due to scatter via scatter correction algorithms.

While only certain features of the invention have been illustrated and described herein, many modifications and changes will occur to those skilled in the art. For example, though the present discussion has been in the context of medical imaging using radiographic systems, one of ordinary skill in the art will appreciate that the present techniques are equally applicable to tomosynthesis systems and also to non-medical imaging applications employing X-ray sources that may move relative to the detection apparatus. For example, the present techniques may also be applied to non-invasive and/or non-destructive imaging techniques used for security and quality control applications in the fields of baggage and package screening, manufacturing quality control, security screening and so forth. It is, therefore, to be understood that the appended claims are intended to cover all such modifications and changes as fall within the true spirit of the invention.

1. A method for generating images, comprising:
acquiring a first image and a second image, wherein the first image is acquired at a lower energy than the second image; and
subtracting the second image from the first image to generate a scatter-reduced image.

2. The method of claim 1, comprising weighting at least one of the first image or the second image prior to subtracting the second image from the first image.

3. A method for generating images, comprising:
acquiring a first image and a second image, wherein the first image is acquired at a lower energy than the second image;
generating at least a low-frequency image and a high-frequency image based on the second image; and
subtracting at least the low-frequency image from the first image to generate a scatter-reduced image.

4. The method of claim 3, comprising weighting at least one of the first image or the low-frequency image prior to subtracting the low-frequency image from the first image.

5. The method of claim 3, wherein generating the low-frequency image and the high-frequency image comprises applying a two-dimensional Fourier transform to the second image.

6. The method of claim 3, comprising adding at least the high-frequency image to the first image.

7. The method of claim 6, comprising weighting at least one of the first image or the high-frequency image prior to adding the high-frequency image to the first image.

8. The method of claim 3, comprising generating an ultra-high frequency image based on the second image.

9. The method of claim 8, comprising subtracting at least the ultra high-frequency image from the first image.

10. The method of claim 9, comprising weighting at least one of the first image or the ultra high-frequency image prior to subtracting the ultra high-frequency image from the first image.

11. One or more tangible, machine readable media, comprising code executable to perform the acts of:
acquiring a first image and a second image, wherein the first image is acquired at a lower energy than the second image; and
subtracting the second image from the first image to generate a scatter-reduced image.

12. The one or more tangible, machine readable media of claim 11, further comprising code executable to perform the acts of:
weighting at least one of the first image or the second image prior to subtracting the second image from the first image.

13. One or more tangible, machine readable media, comprising code executable to perform the acts of:
acquiring a first image and a second image, wherein the first image is acquired at a lower energy than the second image;
generating at least a low-frequency image and a high-frequency image based on the second image; and
subtracting at least the low-frequency image from the first image to generate a scatter-reduced image.

14. The one or more tangible, machine readable media of claim 13, further comprising code executable to perform the acts of:
weighting at least one of the first image or the low-frequency image prior to subtracting the low-frequency image from the first image.

15. The one or more tangible, machine readable media of claim 13, wherein the code executable to perform the act of generating the low-frequency image and the high-frequency image applies a two-dimensional Fourier transform to the second image.

16. The one or more tangible, machine readable media of claim 13, further comprising code executable to perform the acts of:
adding at least the high-frequency image to the first image.

17. The one or more tangible, machine readable media of claim 16, further comprising code executable to perform the acts of:
weighting at least one of the first image or the high-frequency image prior to adding the high-frequency image to the first image.

18. The one or more tangible, machine readable media of claim 13, further comprising code executable to perform the acts of:
generating an ultra-high frequency image based on the second image.

19. The one or more tangible, machine readable media of claim 18, further comprising code executable to perform the acts of:
subtracting at least the ultra high-frequency image from the first image.

20. The one or more tangible, machine readable media of claim 19, further comprising code executable to perform the acts of:
weighting at least one of the first image or the ultra high-frequency image prior to subtracting the ultra high-frequency image from the first image.

21. An imaging system, comprising:
a detector array comprising a plurality of detector elements;
a source configured to emit radiation toward the detector array at two or more energy levels;
a system controller configured to control operation of at least one of the detector array or the source;
an image processing component configured to process signals generated by the detector array in response to radiation emitted at a first energy to generate a first image and to process signals generated by the detector array in response to radiation emitted at a second energy to generate a second image, wherein the image processing component is configured to subtract the second image from the first image to generate a scatter-reduced image.

22. The imaging system of claim 21, wherein the image processing component is further configured to weight at least one of the first image or the second image prior to subtracting the second image from the first image.

23. An imaging system, comprising:
a detector array comprising a plurality of detector elements;
a source configured to emit radiation toward the detector array at two or more energy levels;
a system controller configured to control operation of at least one of the detector array or the source;
an image processing component configured to process signals generated by the detector array in response to radiation emitted at a first energy to generate a first image and to process signals generated by the detector array in response to radiation emitted at a second energy to generate a second image, wherein the image processing component is configured to generate at least a low-frequency image and a high-frequency image based on the second image and to subtract at least the low-frequency image from the first image to generate a scatter-reduced image.

24. The imaging system of claim 23, wherein the image processing component is further configured to weight at least one of the first image or the low-frequency image prior to subtracting the low-frequency image from the first image.

25. The imaging system of claim 23, wherein the image processing component is further configured to generate the low-frequency image and the high-frequency image by applying a two-dimensional Fourier transform to the second image.

26. The imaging system of claim 23, wherein the image processing component is further configured to add at least the high-frequency image to the first image.

27. The imaging system of claim 26, wherein the image processing component is further configured to weight at least one of the first image or the high-frequency image prior to adding the high-frequency image to the first image.

28. The imaging system of claim 23, wherein the image processing component is further configured to generate an ultra-high frequency image based on the second image.

29. The imaging system of claim 28, wherein the image processing component is further configured to subtract at least the ultra high-frequency image from the first image.

30. The imaging system of claim 29, wherein the image processing component is further configured to weight at least one of the first image or the ultra high-frequency image prior to subtracting the ultra high-frequency image from the first image.
